(19) United States
(12) Patent Application Publication
(10) Pub. No.: US 2026/0197432 A1
(43) Pub. Date: Jul. 9, 2026

(54) INTERACTIVE MULTI-VIEW DISPLAY SYSTEM

(71) Applicant: Misapplied Sciences, Inc., Pasadena, CA (US)

(72) Inventors: Albert Han Ng, Pasadena, CA (US); David Steven Thompson, Irvine, CA (US); Shai Renne, Pasadena, CA (US); Mitchell McGlocklin, Los Angeles, CA (US)

(73) Assignee: Misapplied Sciences, Inc., Pasadena, CA (US)

(21) Appl. No.: 19/441,486

(22) Filed: Jan. 6, 2026

Related U.S. Application Data
(60) Provisional application No. 63/742,324, filed on Jan. 6, 2025.

(51) Int. Cl. H04N 13/351; H04N 13/282; H04N 13/368

(52) U.S. Cl. CPC H04N 13/351; H04N 13/282; H04N 13/368

(57) ABSTRACT

A multi-view (MV) display system includes a MV display including MV pixels each configured to emit beamlets in different directions in a beamlet coordinate system toward viewing zones in a viewing zone coordinate system. The MV display system senses a first location of a first user viewer and a second location of a second user viewer; assigns a first identifier to the first user viewer and a second identifier to the second user viewer, wherein the first and second identifiers are different; generates a first registration token and a second registration token, based on the first identifier and the second identifier, respectively; generates a first content based on the first registration token and a second content based on the second registration token; and controls the MV display to direct the first content toward the first location and the second content toward the second location.

### BACKGROUND

### Technical Field

This disclosure relates to a display system, method, and related program, and particularly to a multi-view display including multi-view (MV) pixels capable of directing different content to different viewers in different viewing zones.

### Description of the Related Art

Multi-view displays have the capability to present independent content to each of a plurality of viewers simultaneously. Such displays allow digital experiences that are differentiated for multiple viewers at a time.

### BRIEF SUMMARY

For such multi-view displays to be personalized and/or interactive to each individual, a system to enable viewers to seamlessly register for an experience is desirable.

According to one aspect, a multi-view (MV) display system is provided, which includes:

a multi-view display including MV pixels each configured to emit beamlets in different directions in a beamlet coordinate system toward viewing zones in a viewing zone coordinate system;

a sensing system which, in operation, senses a first location of a first viewer and a second location of a second viewer; and

a system controller processor, which is coupled to the MV display and the sensing system and which, in operation:

receives, from the sensing system, the first and second locations of the first and second viewers, respectively;

assigns a first identifier to the first viewer and a second identifier to the second viewer, wherein the first and second identifiers are different;

generates a first registration token and a second registration token, based on the first identifier and the second identifier, respectively;

generates a first content based on the first registration token and a second content based on the second registration token; and

controls the MV display to direct the first content toward the first location and the second content toward the second location, including:

defining a first viewing zone in the viewing zone coordinate system for the first viewer based on the first location, and a second viewing zone in the viewing zone coordinate system for the second viewer based on the second location;

identifying a first bundle of beamlets from the MV pixels directed toward the first viewing zone to form a first image based on the first content, and a second bundle of beamlets from the MV pixels directed toward the second viewing zone to form a second image based on the second content; and

outputting control signaling for the MV pixels, the control signaling defining color and brightness of the first bundle of beamlets to form the first image visible to the first viewer in the first viewing zone and defining color and brightness of the second bundle of beamlets to form the second image visible to the second viewer in the second viewing zone.

Use of the first and second registration tokens to register the first and second users allows the MV system to seamlessly and interactively present personalized content to the first and second viewers. The first and second registration tokens may comprise, for example, a machine-readable code, an alphanumeric string, a visual pattern sequence, or a visual avatar, which the first and second viewers may input using their mobile devices.

According to another aspect, a method of delivering content in a multi-view display system is provided. The method includes:

arranging a multi-view (MV) display system; the MV display system including a MV display, a sensing system, and a system controller processor, the MV display including MV pixels each configured to emit beamlets in different directions in a beamlet coordinate system toward viewing zones in a viewing zone coordinate system;

sensing a first location of a first viewer and a second location of a second viewer;

assigning a first identifier to the first viewer and a second identifier to the second viewer, wherein the first and second identifiers are different;

generating a first registration token and a second registration token, based on the first identifier and the second identifier, respectively;

generating a first content based on the first registration token and a second content based on the second registration token; and

controlling the MV display to direct the first content toward the first location and the second content toward the second location, including:

defining a first viewing zone in the viewing zone coordinate system for the first viewer based on the first location, and a second viewing zone in the viewing zone coordinate system for the second viewer based on the second location;

identifying a first bundle of beamlets from the MV pixels directed toward the first viewing zone to form a first image based on the first content, and a second bundle of beamlets from the MV pixels directed toward the second viewing zone to form a second image based on the second content; and

outputting control signaling for the MV pixels, the control signaling defining color and brightness of the first bundle of beamlets to form the first image visible to the first viewer in the first viewing zone and defining color and brightness of the second bundle of beamlets to form the second image visible to the second viewer in the second viewing zone.

According to a further aspect, a non-transitory computer readable medium is provided containing content which, when loaded to one or more processors coupled to one or more memory devices, causes the one or more processors to deliver content in a multi-view (MV) display system including a MV display, which includes MV pixels each configured to emit beamlets in different directions in a beamlet coordinate system toward different viewing zones in a viewing zone coordinate system, by:

sensing a first location of a first viewer and a second location of a second viewer;

assigning a first identifier to the first viewer and a second identifier to the second viewer, wherein the first and second identifiers are different;

generating a first registration token and a second registration token, based on the first identifier and the second identifier, respectively;

generating a first content based on the first registration token and a second content based on the second registration token; and

controlling the MV display to direct the first content toward the first location and the second content toward the second location, including:

defining a first viewing zone in the viewing zone coordinate system for the first viewer based on the first location, and a second viewing zone in the viewing zone coordinate system for the second viewer based on the second location;

identifying a first bundle of beamlets from the MV pixels directed toward the first viewing zone to form a first image based on the first content, and a second bundle of beamlets from the MV pixels directed toward the second viewing zone to form a second image based on the second content; and

outputting control signaling for the MV pixels, the control signaling defining color and brightness of the first bundle of beamlets to form the first image visible to the first viewer in the first viewing zone and defining color and brightness of the second bundle of beamlets to form the second image visible to the second viewer in the second viewing zone.

### BRIEF DESCRIPTION OF THE SEVERAL VIEWS OF THE DRAWINGS

FIG. 1 illustrates an embodiment of a multi-view display system;

FIG. 2 illustrates a beamlet coordinate system of the multi-view display system;

FIG. 3 illustrates a viewing zone coordinate system of the multi-view display system;

FIG. 4 depicts an embodiment of a system configuration of the multi-view display system of FIG. 1;

FIGS. 5A, 5B and 5C depict a sample operation of an interactive multi-view display system, in which each viewer is assigned an identifier, uses a mobile device to capture a registration token generated for the viewer based on the identifier, and receives (views) content generated based on the registration token as an personalized image;

FIG. 6 is a flowchart of a sample algorithm executable on an interactive multi-view display system, which enables viewers to seamlessly register to receive personalized content delivery; and

FIG. 7 is a flowchart of another sample algorithm executable on an interactive multi-view display system, which enables viewers to seamlessly register to receive personalized content delivery.

### DETAILED DESCRIPTION

In the following description, for purposes of explanation, various specific details are set forth in order to provide a thorough understanding of the present invention. It will be evident, however, to one skilled in the art that the present invention may be practiced without these specific details. In other instances, well known circuits, structures, and techniques are not shown in detail, but rather in a block diagram in order to avoid unnecessarily obscuring an understanding of this description. Thus, the specific details set forth are merely exemplary. Particular implementations may vary from these exemplary details and still be contemplated to be within the scope of the present invention. Reference in the description to "one embodiment" or "an embodiment" means that a particular feature, structure, or characteristic described in connection with the embodiment is included in at least one embodiment of the invention. The phrase "in one embodiment" located in various places in this description does not necessarily refer to the same embodiment.

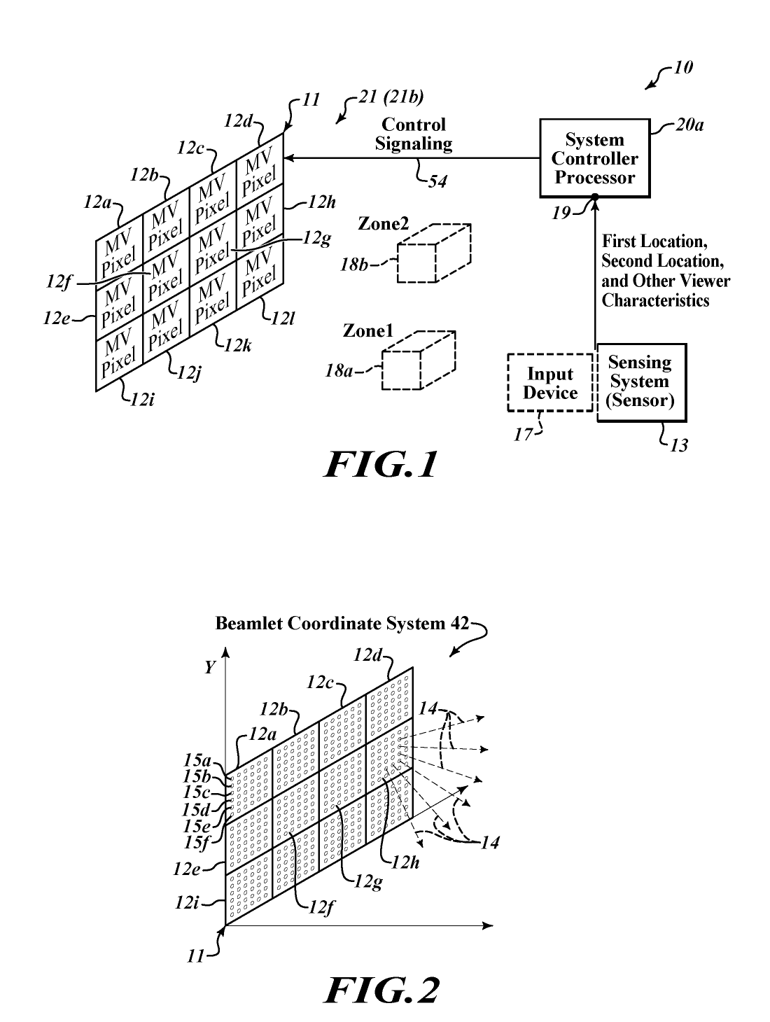

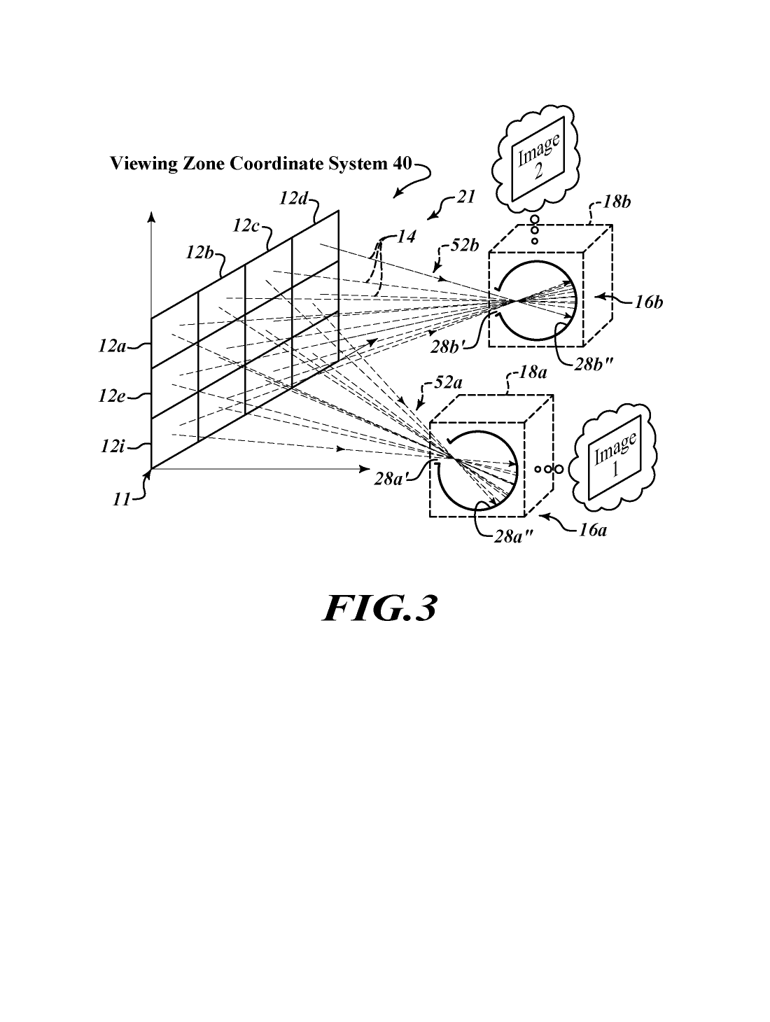

FIG. 1 depicts an embodiment of a multi-view display system 10. The multi-view display system 10 includes at least one multi-view (MV) display 11 including MV pixels 12 (twelve MV pixels 12a-12l are included in the illustrated example), wherein each MV pixel 12 is configured to emit beamlets 14 (see FIG. 2) in different directions in a beamlet coordinate system 42. "Beamlets" as used herein means individually controllable beams emitted from multiple origins 15a, 15b, 15c, etc. included in an MV pixel. In various embodiments, the beamlet origins 15a, 15b, 15c, etc. correspond to image pixels (display panel pixels) within a MV pixel 12.

FIG. 2 schematically depicts the beamlet coordinate system 42, which may be any suitable coordinate system such as a Cartesian coordinate system and a polar coordinate system. The beamlet coordinate system 42 identifies each of the beamlets 14 emitted from each MV pixel 12, which follows a specific propagation path. For example, the propagation path of each beamlet may be defined by the beamlet's origin in the MV pixel and the (unit) vector that defines its propagating direction, or may be characterized by a combination of angles such as azimuth α and altitude ß angles formed by the beamlet. As further examples, any suitable 3D space modeling method may be used to define the beamlets' propagation paths in the beamlet coordinate system 42, such as a point cloud method that specifies a set of data points that form each propagation path or a voxel data method that specifies a set of voxels (a volume having unit x-y-z dimensions) that form each propagation path.

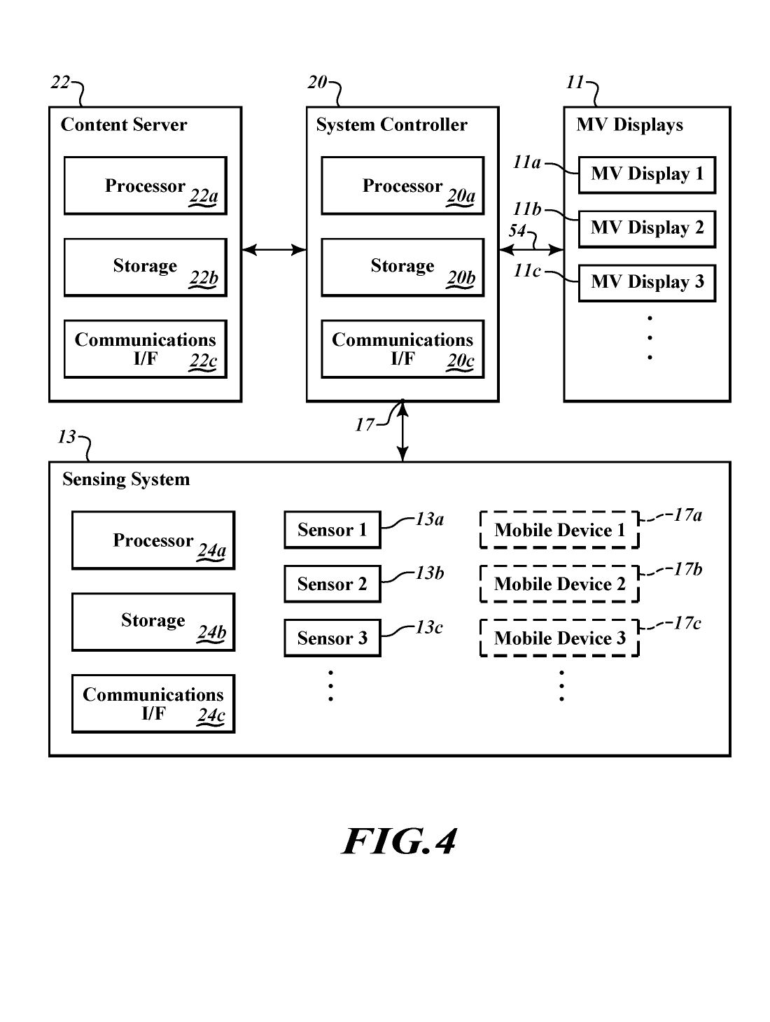

Referring additionally to FIG. 3, the beamlets 14 from each of the MV pixels 12a-12l are intended to fall upon the eyes of multiple (first and second) viewers 16a and 16b, such that the multiple viewers 16a and 16b respectively see different bundles of beamlets 52a and 52b (e.g., in different colors and brightness) originating from the same set of MV pixels 12. As a consequence, the appearance of each MV pixel 12 from the perspective of a viewer is dependent upon the location and angle at which the viewer looks to the MV pixel 12. For ease of illustration the MV pixel 12h is depicted to emit several beamlets 14 in FIG. 3, though it should be understood that many more beamlets 14 may be emitted from each of the MV pixels 12a-12l. As illustrated in FIG. 1 and 3, a first viewing zone 18a is defined around a location of the first viewer 16a (or the first viewer’s eye in the illustrated example), and a second viewing zone 18b is defined around a location of the second viewer 16b (or the second viewer’s eye in the illustrated example). Both of the first and second viewing zones 18a and 18b are defined in a viewing area 21 in a viewing zone coordinate system 40 of the MV display 11. The viewing area 21 may be defined as a three-dimensional volume or a two-dimensional area, from which a viewer can see content displayed on the MV display 11. The first and second viewing zones 18a and 18b in the illustrated example are specified as three-dimensional volumes (e.g., boxes), located relative to the MV pixels 12 of the MV display 11 within the viewing area 21 of the MV display 11. Each viewing zone 18a, 18b defines an observation point at which an image formed by the bundle of beamlets 52a or 52b from the MV pixels 12a-12l is visible (“Image 1” or “Image 2”). Thus, the viewing zone 18a, 18b may be defined as a three-dimensional volume (a collection of observation points in 3D), as a two-dimensional area (a collection of observation points in 2D), or as a point.

Referring to FIG. 1, the MV display system 10 includes a sensing system 13 and a system controller processor 20a. The sensing system 13 may sense a first location of a first viewer 16a and a second location of a second viewer 16b, detect other viewer characteristics of the first and second viewers 16a/16b, and transmit the detection signals indicative of the first location, the second location, and any other viewer characteristics to the system controller processor 20a.

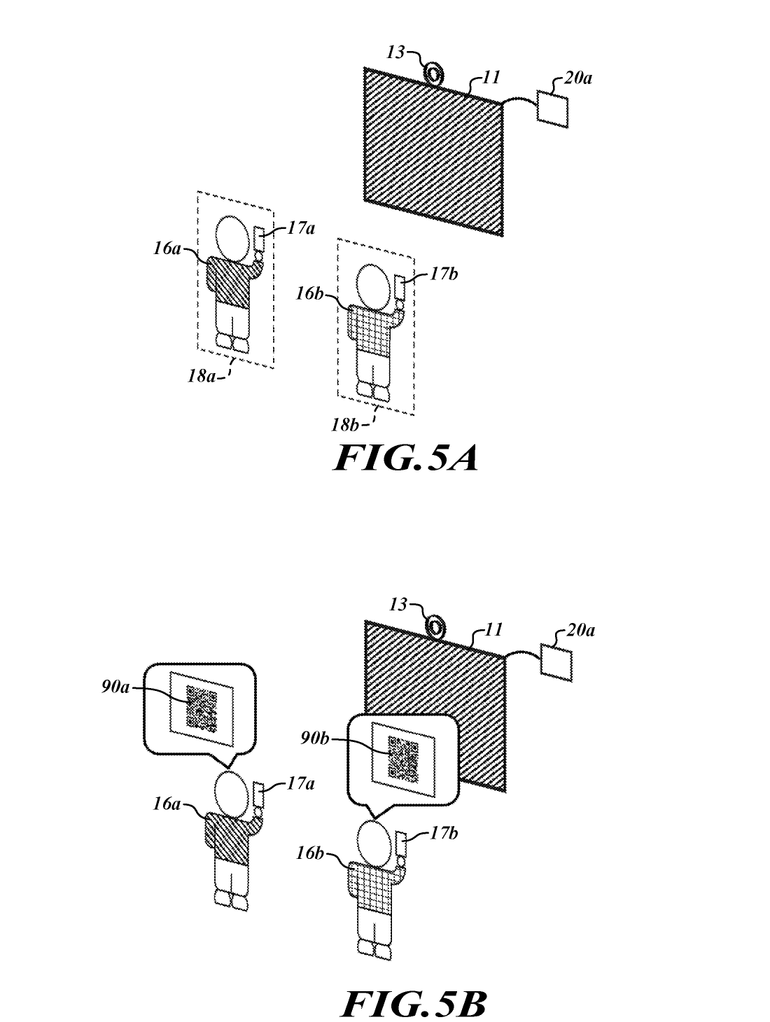

The system controller processor 20a may define, based on the received first and second locations of the first and second viewers 16a/16b, the first and second viewing zones 18a/18b located relative to the MV display 11 in the viewing area 21 in the viewing zone coordinate system 40. Specifically, a point, a 2D shape, and/or a 3D shape may be assigned to each detected viewer 16 (e.g., a 3D box that encloses the viewer 16), and the assigned point, 2D shape and/or 3D shape may be used to define the viewing zone 18 of the viewer 16. Definition of the first and second viewing zones 18a, 18b may be performed in any consolidated or distributed processing configuration. For example, the sensing system processor 24a (see FIG. 4) may define the first and second locations of the first and second viewers 16a and 16b as the first and second viewing zones 18a and 18b, respectively, which may then be inputted to the system controller processor 20a via an input node 19.

In FIG. 3, the viewing zone coordinate system 40 may be any suitable coordinate system, such as a Cartesian coordinate system, or a polar coordinate system in which multiple viewing zones are positioned to surround the one or more MV pixels, for example. Any suitable 3D space modeling method may be used to define the viewing zone coordinate system 40, such as a map, point cloud, wire polygon mesh, and textured polygon mesh.

As illustrated in FIG. 3, the bundle of beamlets 52a includes the beamlets 14 that are “hitting” the pupil 28a’ to be spread to the retina 28a” of the first viewer 16a to form “Image 1” visible to the first viewer 16a in the first viewing zone 18a. The bundle of beamlets 52b includes the beamlets 14 that are “hitting” the pupil 28b’ to be spread to the retina 28b” of the second viewer 16b to form “Image 2” visible to the second viewer 16b in the second viewing zone 18b.

Since the propagation paths of the beamlets 14 are defined in the beamlet coordinate system 42 of FIG. 2, while the viewing zones 18a, 18b, to which the bundles 52a, 52b of beamlets 14 are directed, are defined in the viewing zone coordinate system 40, a mapping is determined that translates between the viewing zone coordinate system 40 and the beamlet coordinate system 42. The mapping is used to identify a specific bundle of beamlets 52a, 52b, defined in the beamlet coordinate system 42, which are directed toward a specific viewing zone 18a, 18b, defined in the viewing zone coordinate system 40, to form the respective Images 1 and 2.

The mapping may take any of various forms, such as a table or a mathematical relationship expressed in one or more translational functions, as will be apparent to those skilled in the art. In some embodiments, the mapping may be based on registration of reference indicia (e.g., points, lines, shapes) defined in the viewing zone coordinate system 40 and in the beamlet coordinate system 42. For example, a computer sensing system (a first camera) attached to the one or more MV pixels 12 is used to capture images of a registration pattern of a registration device placed in the viewing area 21 of the MV pixels 12. In one embodiment, the registration pattern is a checkerboard pattern attached to the registration device. The computer sensing system images the checkerboard pattern in the viewing area 21, and uses image processing techniques to calculate the coordinates of the registration device in the viewing zone coordinate system 40. In another embodiment, the registration pattern is generated by a light source (e.g., an LED) attached to the registration device in the viewing area 21. The light source is flashed, which is captured by the computer sensing system (first camera) of the MV pixels 12, and the location of the flashing light source in the viewing area 21 imaged by the first camera may serve as a reference in the viewing zone coordinate system 40 (which may be based on the coordinate system of the first camera).

Encoding patterns (e.g., Gray-code patterns, non-return-to-zero (NRZ) digital sequences, amplitude-shift-keyed (ASK) bits, maximum-length sequences, shift-register sequences) are flashed on the one or more MV pixels 12 (by selectively turning on and off the beamlets 14 on each MV pixel 12) to uniquely encode every beamlet 14 emitted from each MV pixel 12. Each of the uniquely-encoded beamlets 14 from each MV pixel 12 can be captured by a second camera of the registration device placed in the viewing area 21 and identified to be used as a reference in the beamlet coordinate system 42.

The same process of calculating coordinates of a reference in the viewing zone coordinate system 40 and a reference in the beamlet coordinate system 42 may be repeated with the registration device moved to different positions in the viewing area 21, to thereby obtain a set of references in the viewing zone coordinate system 40 and a set of references in the beamlet coordinate system 42. The mapping that translates between the two coordinate systems 40 and 42 may be found so as to register, align, or otherwise correlate these two sets of references in the two coordinate systems 40 and 42. Any other registration techniques in image processing, such as automatic 3D point cloud registration, may also be used to perform the registration.

Referring back to FIG. 2, the MV pixel 12 may be formed of display panel (e.g., LCD, LED, OLED, etc.) over which a lens or an array of lenses is placed, such that each of the display panel pixels 15a-15f within the MV pixel 12 functions as an individually addressable light source (i.e., origin) that emits light (i.e., beamlet) when electrically excited by control signaling 54 from the system controller processor 20a, to be described below.

Referring back to FIG. 1, the system controller processor 20a (see also FIG. 4) includes the input node 19 which, in operation, receives viewer characteristics such as the first and second locations of the first and second viewers 16a/16b from the sensing system (sensor) 13 and may receive user input via a user interface of an input device 17. As shown in FIG. 4, examples of the input device 17 include mobile devices 17a, 17b, 17c of the first, second, and third viewers, respectively, or a kiosk including a camera, a scanner, a touch screen, etc. as a user interface.

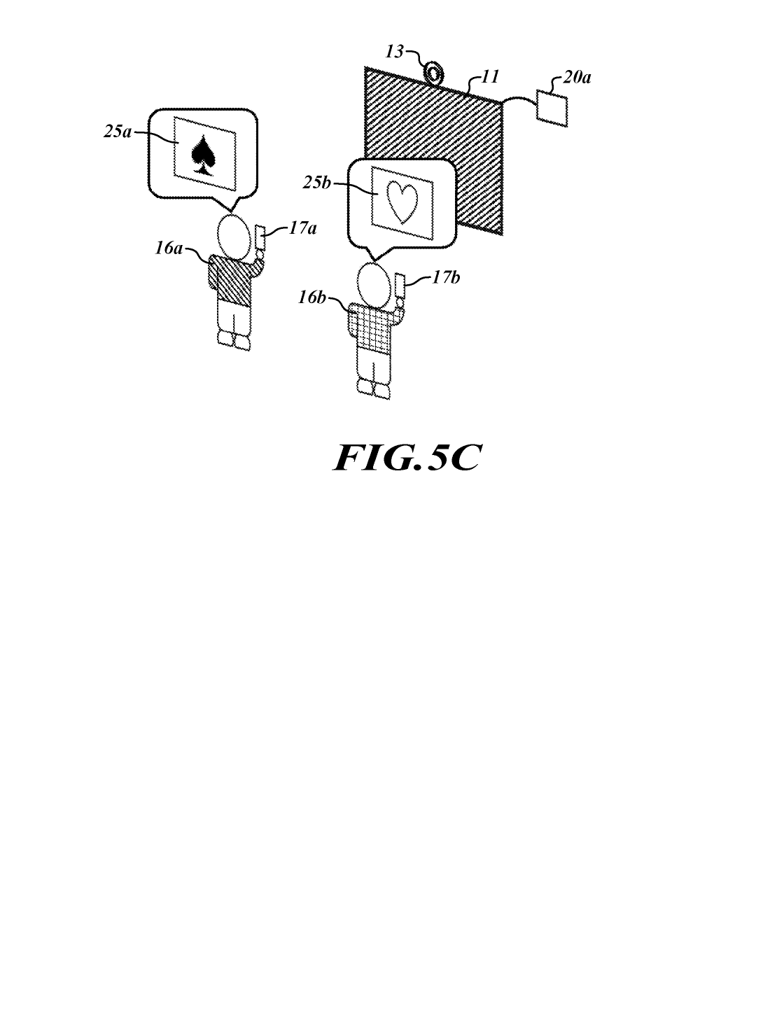

FIGS. 5A, 5B and 5C depict a sample operation of the multi-view display system 10 to seamlessly register the first and second viewers 16a and 16b to deliver personalized content to each user, interactively.

In FIG. 5A, the sensing system 13 (e.g. a camera) is arranged relative to the MV display 11 to sense the first and second locations of the first and second viewers 16a/16b, respectively. The system controller processor 20a assigns a first identifier to the first viewer 16a and assigns a second identifier to the second viewer 16b, wherein the first and second identifiers are different. Referring additionally to FIG. 5B, the system controller processor 20a generates a first registration token 90a and a second registration token 90b, based on the first identifier and the second identifier, respectively. Referring additionally to FIG. 5C, the system controller 20a generates a first content (corresponding to a first image 25a) based on the first registration token 90a and a second content (corresponding to a second image 25b) based on the second registration token 90b, and control the MV display 11 to direct the first content toward the first location and the second content toward the second location such that the first and second viewers 16a/16b see the first and second images 25a/25b, respectively.

Specifically, the system controller processor 20a defines a first viewing zone 18a in the viewing zone coordinate system 40 for the first viewer 16a based on the first location sensed by the sensing system 13, and defines a second viewing zone 18b in the viewing zone coordinate system 40 for the second viewer 16b based on the second location sensed by the sensing system 13.

The system controller processor 20a identifies a first bundle of beamlets 52a (FIG. 3) from the MV pixels 12 directed toward the first viewing zone 18a to form the first image 25a based on the first content, and identifies a second bundle of beamlets 52b from the MV pixels 12 directed toward the second viewing zone 18b to form the second image 25b based on the second content.

The system controller processor 20a outputs control signaling 54 for the MV pixels 12 of the MV display 11, as shown in FIGS. 1 and 4. The control signaling defines color and brightness of the first bundle of beamlets 52a to form the first image 25a visible to the first viewer 16a in the first viewing zone 18a and defines color and brightness of the second bundle of beamlets 52b to form the second image 25b visible to the second viewer 16b in the second viewing zone 18b. As a result, the first viewer 16a in the first viewing zone 18a sees the first image 25a on the MV display 11, while the second viewer 16b in the second viewing zone 18b sees the second image 25b on the MV display 11.

FIG. 4 depicts a sample system configuration of the multi-view display system 10 of FIG. 1. There may be a content server 22, one or more MV displays 11a-11c, and one or more sensors 13a-13c (of the sensing system 13) all coupled to a system controller 20, which includes one or more processors 20a, 22a, 24a (including the system controller processor 20a), in any suitably distributed manner, although in other embodiments their functionalities may be distributed in different manners or may be consolidated into a single element. The processors 20a, 22a, 24a may be a general-purpose computer capable of, among other tasks, executing an operating system, executing various device drivers, and executing specialized application software used in conjunction with various embodiments of the invention. In some embodiments, the processors 20a, 22a, 24a may be a special-purpose processor, collectively or individually. The processor 20a, 22a, 24a is capable of populating, updating, using and managing data in a processor-accessible memory or storage 20b, 22b, 24b. Briefly, the storage 20b, 22b, 24b is a volatile storage device (e.g., RAM) and/or a non-volatile, non-transitory storage device (e.g., ROM, EPROM, EEPROM, hard drive(s), flash drive(s) or other solid state memory technology, CD-ROM, DVD) capable of storing, among any other information, data, device drivers and specialized application software which, when executed, enables the processor 20a, 22a, 24a to perform various computations and processing as described in the present disclosure. Various components in the processors 20a, 22a, 24a may be realized by hardware, software, or a combination of hardware and software, and each component may be partly or entirely realized by circuitry, a general-purpose processor or a special-purpose processor executing a software algorithm.

The sensing system 13 in the illustrated embodiment includes the sensors 13a-13c coupled to a processor 24a, a storage 24b, and a communications interface 24c. The sensors 13a-13c may be configured to sense the characteristics of the viewers such as each viewer’s location, velocity, acceleration, moving direction, face, and various other viewer characteristics or data usable for specifying the viewing zone for each viewer as well as for delivering personalized content to each viewer.

To sense the first location and other viewer characteristics of the first viewer 16a and the second location and other viewer characteristics of the second viewer 16b, the sensors 13a, 13b, 13c, et seq. may include sensors based on any suitable sensing technology including an optical sensor (e.g., camera, video camera, infrared sensor), an ultrasonic sensor, an acoustic sensor, a thermal imaging sensor, an electromagnetic (EM) interrogation system sensor capable of tracking an active object held/carried by a viewer, a GPS system sensor capable tracking an active object held/carried by a viewer, an RF sensor (e.g., RFID system including a reader capable of interrogating an RFID tag held/carried a viewer), an RF triangulation technique-based sensor, a radar sensor, biometric sensors, interaction sensors (e.g., capacitive sensors to determine when a viewer touches an object), motion sensors, sensors to detect presence of a personal device (e.g., mobile device 17a-17c) such as a cell phone, a smartphone or a tablet as well as to discover information from the personal device, vehicle detection and identification systems, temperature sensors (e.g., heat emanating from the viewer), microphones (e.g., speech or other sound made by the viewer), etc. The sensing system 13 may work independently, or may draw on other sources of data to detect, distinguish or determine various characteristics. For example, the sensing system 13 may detect a particular cell phone in range, and then query an external database to find the viewer’s identify, demographic information, preferences, movement history, etc.

The multiple sensors 13a, 13b, 13c, et seq. may be suitably located relative to each other and relative to the MV displays 11a-11c to comprehensively detect the locations and other characteristics of the first and second viewers 16a, 16b as they move around a physical setting where the multi-view display system 10 is installed such as at an airport, a train station, a convention center, an amusement park, etc.

For example, one or more cameras 13 having suitable lenses and lighting may be used to sense the first and second locations of the first and second viewers 16a and 16b to define corresponding viewing zones 18a and 18b, respectively, as shown in FIGS. 5A-5C. In some embodiments, the camera(s) may be depth-aware cameras, such as structured light or time-of-flight cameras, which can generate a depth map of what is being seen through the camera at a short range. The depth map may then be processed to approximate a 3D representation of what is being seen. In other embodiments, the camera(s) may be stereoscopic cameras and/or LIDAR sensors. Multiple sensors 13 of the same type, or of different types, may be used together. The sensing system processor 24a may run software applications (stored in the storage 24b) such as image processing software or facial recognition software to process images captured by the sensors 13a-13c, software that associates each identified viewer 16a, 16b with a viewing zone 18a, 18b, software that discerns or extracts characteristics of each detected viewer, etc. Any of a number of image processing techniques may be used including, without limitation, stitching/registration, morphological filtering, thresholding, pixel counting, image segmentation, face detection/recognition, edge detection, blob discovery and manipulation.

In some embodiments, the sensing system 13 includes (or is used with) mobile devices 17a, 17b, etc. associated with the viewers 16a, 16b, etc., respectively, which can facilitate detection of the characteristics (e.g., location, identity, etc.) of each viewer as well as interactive operation of the MV display system 10. The mobile devices 17a-17c may be, as non-limiting examples, smartphones, smartwatches, tablets, etc., including a user interface. The mobile devices 17a-17c may be user surrogate devices such as tags (e.g., passive patterns such as QR code, active optical tags such as blinking IR LEDs, radio tags such as RFID tags, or ultrasonic tags) that the viewers may carry or wear, conveyors that may transport the viewers such as vehicles, or any other types of markers that may serve as surrogates of the viewers.

The mobile devices may include a user interface (e.g., a smartphone, a tablet computer, a laptop, or a smartwatch), via which the viewer may input information to the multi-view display system 10, such as the viewer’s identity, biometric information, and demographic information. Also, the mobile devices without a user interface, such as a laser pointer, may be used by the viewers to input viewer characteristics to the multi-view display system 10. Referring back to FIG. 1, the mobile devices 17a-17c may function as the input device 17 to enter viewer characteristics to the multi-view display system 10.

The sensors 13 may be configured to communicate with (e.g., receive signals from, interrogate, etc.) the mobile devices 17a-17c respectively associated with the viewers using any suitable sensing or location technologies or protocols such as Bluetooth, Wi-Fi, cellular, optical, ultrasound, or RFID technology, EM interrogation technology, or GPS technology. The sensing system communications interface (I/F) 24c is responsible for supporting wireless communications among the sensors 13a-13c, the mobile devices 17a-17c, the sensing system processor 24a, and the system controller 20 using any suitable communications protocols.

As used herein, "image" means anything that results from a pattern of illumination from the MV pixels 12. The pattern of illumination is generated by turning "on" or "off" each of the beamlets 14 emitted from each MV pixel 12 and/or controlling color and brightness (intensity) of each of the beamlets. The content server 22 includes a processor 22a, storage 22b which stores various content (or content descriptors or content types), and communications interface (I/F) 22c. Alternatively or additionally, the content server 22 may include interfaces that feed content from content providers, such as a feed from a live camera or a broadcasting station. Further alternatively or additionally, the system controller processor 20a may generate the first and second content on the fly using computer-executable algorithms, which may be stored in the content server 22.

The system controller 20, the content server 22, the sensing system 13 and the MV displays 11a-11c may communicate with each other, in a network setting, via their respective communications interfaces (I/F) 20c, 22c, 24c, via any suitable medium including wireline and/or wireless medium, and via any suitable protocol (e.g., Bluetooth, Wi Fi, cellular, optical, ultrasound).

For example, the control signaling 54 for the MV pixels 12 may be output from the communications interface (I/F) 20c of the system controller 20 via any suitable medium including wireline and/or wireless medium, and via any suitable protocol (e.g., Bluetooth, Wi-Fi, cellular, optical, ultrasound).

The system controller 20 is generally responsible for controlling the multi-view display system 10 to deliver different images to different viewers 16a, 16b present at different viewing zones 18a, 18b in the viewing area 21 in the viewing zone coordinate system 40 of the MV display(s) 11. The system controller 20 includes the processor 20a, which may run software applications (stored in the storage 20b) to define the first and second viewing zones 18a, 18b in the viewing area 21. For example, the first and second viewing zones 18a, 18b may be dynamically defined around the first and second viewers 16a, 16b detected by the sensing system 13, and continually updated as the first and second viewers 16a, 16b move around relative to the MV display(s) 11.

As shown in FIG. 5A, in one embodiment, a multi-view display system comprises a multi-view display 11 and a sensing system 13 (e.g., a camera above the multi-view display 11) that detects the locations of each viewer. A system controller processor 20a coupled to the multi-view display 11 and sensing system 13 defines a viewing zone 18a/18b for each viewer 16a/16b based on the viewer’s location, and a content stream for each viewer. The multi-view display 11 directs each viewer’s content stream toward the viewing zone 18a/18b of the respective viewer 16a/16b, such that each viewer sees different content at the same time. The system controller processor 20a assigns an identifier, such as an alphanumeric code, to each viewer 16a/16b. Referring additionally to FIG. 5B, each viewer’s identifier is encoded into a registration token 90a/90b, such as a QR code or visual password, which is embedded into the viewer’s associated content stream. As illustrated, each viewer 16a/16b sees a different token 90a/90b on the same multi-view display 11. Each viewer can then use a mobile device 17a/17b to capture their respective token 90a/90b, which opens a communication session with the system controller processor 20a, such as via a web or mobile application, as illustrated in FIG. 5C. The viewer’s identifier is communicated to the system controller processor 20a during the session, such that the system controller processor 20a associates the viewer’s communication session with their respective content stream. The viewer can then interact with a user interface on their mobile device 17a/17b to provide input communicated to the system controller processor 20a. Based on the user interface input, the system controller processor 20a modifies the visual imagery of the content stream 25a/25b directed toward the viewer.

For example, multiple viewers 16a/16b can be simultaneously viewing a multi-view display 11with the intent to watch different channels. Each viewer first sees a QR code 90a/90b on the display 11, with each viewer being assigned a different QR code. A viewer can scan the QR code they see using their mobile device 17a/17b, which brings up an application with an interface portraying a remote control. The viewer can then interact with the remote control interface to select the channel they see on the multi-view display 11. Multiple viewers 16a/16b can simultaneously control the same multi-view display 11 with their mobile devices 17a/17b, and each see different content 25a/25b, as shown in FIG. 5C.

In the aforementioned embodiment, each detected viewer can be assigned a numeric ID number. The QR code each viewer sees can encode a web URL with the viewer’s ID number embedded within. For example, a first viewer with ID number 42 can see a QR code with the embedded URL “www.misappliedsciences.com/demo?id=42”, while simultaneously a second viewer with ID number 75 can see a QR code with the embedded URL “www.misappliedsciences.com/demo?id=75”. When each viewer uses their mobile device 17a/17b to scan their respective QR code, a session on a web application at “www.misappliedsciences.com/demo” is started that is assigned to their ID number. The system controller processor 20a receives inputs during the viewer’s web application session, and associates those inputs with the viewer content stream that is assigned to the ID number. The system controller processor 20a then alters the viewer content stream, and causes the multi-view display 11 to update so the viewer sees that content is reacting to their input (i.e., the viewer content delivery is interactive).

Other forms of machine-readable visual codes may be used, including but not limited to, Data Matrix, Aztec Code, PDF417, MaxiCode, Code One, DotCode, Micro QR Code, NTIN Code, PPN Code, Codablock, MicroPDF417, Code 49, Code 16K, Han Xin Code, VeriCode, JAB Code, Ultracode, High Capacity Color Barcode, Universal Product Code, European Article Number, Code 39, Code 128, Interleaved 2 of 5, Codabar, MSI Plessey, GS1 DataBar, and/or POSTNET, Pharmacode. It is well known in the art that other codes are possible, and do not depart from the scope of the disclosed invention.

In another embodiment of the invention, the system controller processor 20a assigns a different password to each viewer 16a/16b. Each viewer sees only their own assigned password on the multi-view display 11. A viewer can type the password they see into an application on their mobile device 17a/17b, opening up a communication session associated with the password with the system controller processor 20a. The viewer can then interact with their mobile device - for example through interface elements such as buttons, sliders, text inputs, or gestures - which communicates the inputs for the session to the system controller processor 20a. The system controller processor 20a can alter the content for the content stream associated with the password and session, such that the viewer 16a/16b perceives the content they see as reacting to their mobile device input.

For example, multiple viewers 16a/16b can engage in a personalized scavenger hunt or interactive game. Each viewer is assigned a different passphrase, and the viewers discover their unique passphrase as they look at the multi-view display 11. Each viewer then enters their passphrase into an application on their mobile device 17a/17b, establishing a game session for the viewer. The viewer can then interact with the content on the multi-view display 11 that only they can see, such as through button presses or gestures with the mobile device 17a/17b.

In another embodiment of the invention, the registration token 90a/90b can take the form of a visual pattern sequence – for example, a color and shape sequence. The first viewer 16a can see their registration token 90a as a red circle, blue square, then yellow triangle, while the second viewer 16b can see their registration token 90b as a green star, pink octagon, then orange trapezoid. The mobile device interface can show possible color and shape combinations, and the viewers 16a/16b would input the sequence of shapes and colors they see on the display 11 as their registration token.

In another embodiment, the registration token 90a/90b can be a visual avatar – for example, a member of a possible cast of characters. The mobile device interface can show the possible cast of characters, and the viewers 16a/16b would select the respective avatar they were assigned.

It is noted that in the aforementioned embodiments, different viewers 16a/16b can be in different registration states at the same time. For example, a first viewer 16a may approach the multi-view display 11, capture their registration token 90a using their mobile device 17a, and begin their interactive session. Then later, a second viewer 16b may approach the multi-view display 11 and see their assigned registration token 90b, while the first viewer 16a is already seeing their interactive content 25a since the first viewer 16a has been registered.

### Other Examples

Each viewer (or group or class of viewers) looking at the multi-view display 11 is shown one or more graphical elements. For example, the first viewer 16a might see an elephant, monkey, and dog; while the second viewer 16b sees a pig, parrot, and cat. Each viewer could then use an application on a personal or shared device to visually identify the shapes (e.g., with a camera or pictorial interface); or might speak the name of each shape or mimic sounds associated with it (e.g., with a personal, shared, or remote directional microphone); or might physically mimic the behaviors or appearance associated with each shape (e.g., to be observed by a camera, sensor, AI, or through analysis of sensors on a personal device); or might type in the name of each shape, or draw the shape. Some of these techniques might be especially useful for persons who have challenges using traditional communication techniques, as well as for non-local speaking audiences, and with children, and even animals.

Each viewer looking at the display 11 is shown avatars, characters, colors, patterns, phrases, names, or other visual cues, individually or as a set. Making a selection among the choices provides the viewer (or group or class of viewers) with an identity, label, and/or URL. It may be desirable on a given day or session to remove the option selected by a viewer from options available to subsequent viewers.

Audio or sensory cues provided on a personal device or in the environment might cue a viewer or viewers how to identify themselves to the system 10, opt in, and/or access a URL.

Each viewer might enter or select the answer or results to a puzzle, question, or scavenger hunt as part of the process.

The choices made by viewers using these techniques might directly or indirectly provide information about themselves such as their preferences, interests, skills, language, background, and so forth that can be used to shape their interaction with the system 10.

The previously described embodiments are non-limiting examples, and alternative embodiments, permutations, hybrids, orderings, arrangements, and implementations may be possible and do not depart from the scope of the disclosed invention.

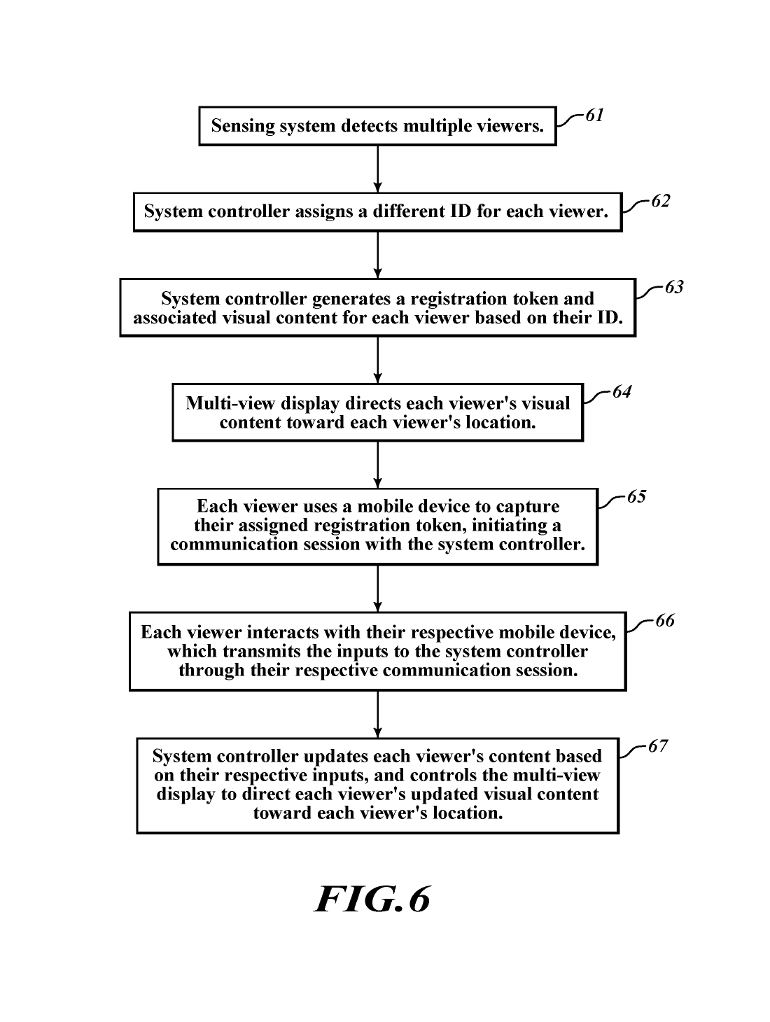

FIG. 6 is a flow chart of a sample algorithm executable on an interactive multi-view display system 10, which enables viewers to seamlessly register to receive personalized content according to one embodiment.

In step 61, the sensing system 13 of the multi-view display system 10 detects multiple viewers 16a/16b.

In step 62, the system controller processor 20a of the multi-view display system 10 assigns a different ID for each viewer.

In step 63, the system controller processor 20a generates a registration token 90a/90b and associated visual content for each viewer 16a/16b based on their ID.

In step 64, the multi-view display 11 directs each viewer’s visual content toward each viewer’s location.

In step 65, each viewer 16a/16b uses a mobile device 17a/17b to capture their registration token 90a/90b, initiating a communication session with the system controller processor 20a.

In step 66, each viewer 16a/16b interacts with their respective mobile device 17a/17b, which transmits the inputs to the system controller processor 20a through their respective communication session.

In step 67, the system controller processor 20a updates each viewer’s content based on their respective inputs, and controls the multi-view display 11 to direct each viewer’s updated visual content 25a/25b toward each viewer’s location.

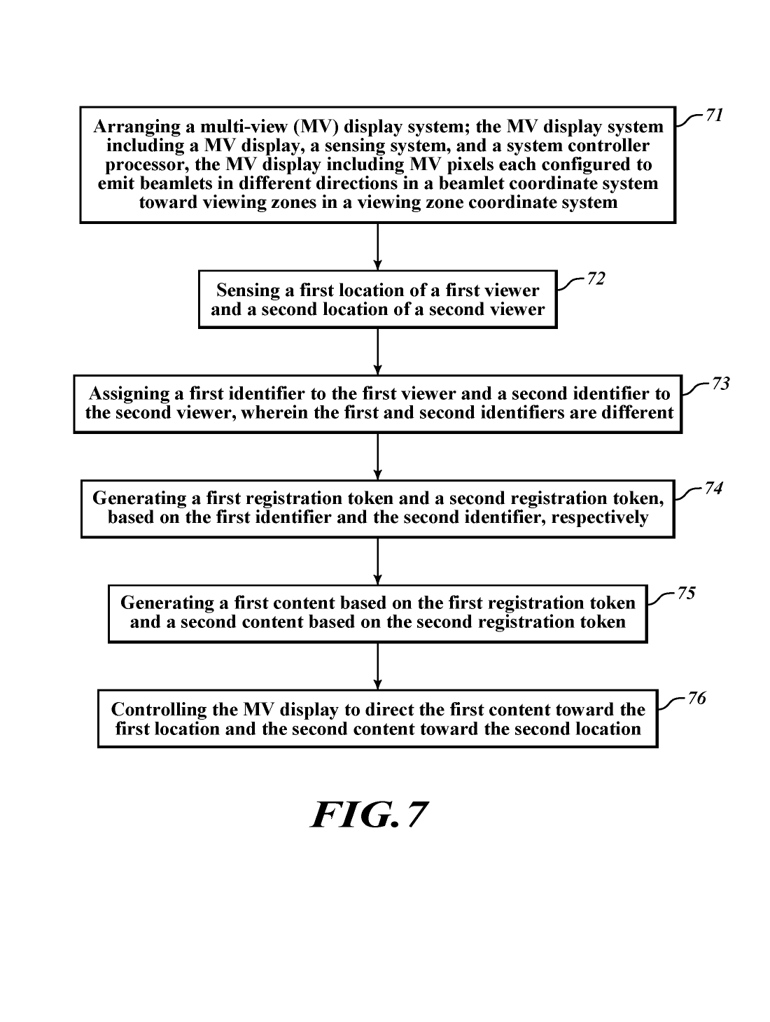

FIG. 7 is a flow chart of another sample algorithm executable on an interactive multi-view display system 10, which enables viewers to seamlessly register to receive personalized content according to one embodiment.

In step 71, the multi-view display system 10 is arranged, which includes a MV display 11, a sensing system 13, and a system controller processor 20a, wherein the MV display 11 includes MV pixels 12 each configured to emit beamlets 14 in different directions in a beamlet coordinate system 42 toward viewing zones 18a/18b in a viewing zone coordinate system 40.

In step 72, the sensing system 13 senses a first location of a first viewer 16a and a second location of a second viewer 16b.

In step 73, the system controller processor 20a assigns a first identifier to the first viewer 16a and a second identifier to the second viewer 16b, wherein the first and second identifiers are different.

In step 74, the system controller processor 20a generates a first registration token 90a and a second registration token 90b, based on the first identifier and the second identifier, respectively.

In step 75, the system controller processor 20a generates a first content (25a) based on the first registration token 90a and a second content (25b) based on the second registration token 90b.

In step 76, the system controller processor 20a controls the MV display 11 to direct the first content (25a) toward the first location and the second content (25b) toward the second location.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A multi-view (MV) display system, comprising:
a multi-view display including MV pixels each configured to emit beamlets in different directions in a beamlet coordinate system toward viewing zones in a viewing zone coordinate system;
a sensing system which, in operation, senses a first location of a first viewer and a second location of a second viewer; and
a system controller processor, which is coupled to the MV display and the sensing system and which, in operation:
receives, from the sensing system, the first and second locations of the first and second viewers, respectively;
assigns a first identifier to the first viewer and a second identifier to the second viewer, wherein the first and second identifiers are different;
generates a first registration token and a second registration token, based on the first identifier and the second identifier, respectively;
generates a first content based on the first registration token and a second content based on the second registration token; and
controls the MV display to direct the first content toward the first location and the second content toward the second location, including:
defining a first viewing zone in the viewing zone coordinate system for the first viewer based on the first location, and a second viewing zone in the viewing zone coordinate system for the second viewer based on the second location;
identifying a first bundle of beamlets from the MV pixels directed toward the first viewing zone to form a first image based on the first content, and a second bundle of beamlets from the MV pixels directed toward the second viewing zone to form a second image based on the second content; and
outputting control signaling for the MV pixels, the control signaling defining color and brightness of the first bundle of beamlets to form the first image visible to the first viewer in the first viewing zone and defining color and brightness of the second bundle of beamlets to form the second image visible to the second viewer in the second viewing zone.

2. The MV display system of claim 1, further comprising a mobile device, which is located in proximity to the first location and which, in operation:
captures the first registration token;
transmits the first registration token to the system controller processor to initiate a communication session associated with the first viewer;
receives an input from the first viewer; and
transmits the received input to the system controller processor through the communication session,
wherein the system controller processor:
updates the first content based on the received input; and
controls the MV display to direct the updated first content toward the first location.

3. The MV display system of claim 2, wherein
the first registration token comprises a machine-readable code, and
the capture of the first registration token includes using a camera on the mobile device to scan the machine-readable code.

4. The MV display system of claim 3, wherein the machine-readable code comprises a QR Code, Data Matrix code, Aztec Code, PDF417 code, High-Capacity Color Barcode, or Universal Product Code.

5. The MV display system of claim 2, wherein
the first registration token comprises an alphanumeric string, and
the capture of the first registration token includes the first viewer entering the first registration token into a text field on the mobile device.

6. The MV display system of claim 2, wherein
the first registration token comprises a visual pattern sequence, and
the capture of the first registration token includes the first viewer entering the visual pattern sequence of the first registration token into a user interface on the mobile device.

7. The MV display system of claim 2, wherein
the first registration token comprises a visual avatar, and
the capture of the first registration token includes the first viewer selecting the visual avatar of the first registration token amongst a plurality of options in a user interface on the mobile device.

8. The MV display system of claim 1, wherein the sensing system includes a camera mounted on the MV display or arranged in proximity to the MV display.

9. A method of delivering content in a multi-view display system, the method comprising:
arranging a multi-view (MV) display system; the MV display system including a MV display, a sensing system, and a system controller processor, the MV display including MV pixels each configured to emit beamlets in different directions in a beamlet coordinate system toward viewing zones in a viewing zone coordinate system;
sensing a first location of a first viewer and a second location of a second viewer;
assigning a first identifier to the first viewer and a second identifier to the second viewer, wherein the first and second identifiers are different;
generating a first registration token and a second registration token, based on the first identifier and the second identifier, respectively;
generating a first content based on the first registration token and a second content based on the second registration token; and
controlling the MV display to direct the first content toward the first location and the second content toward the second location, including:
defining a first viewing zone in the viewing zone coordinate system for the first viewer based on the first location, and a second viewing zone in the viewing zone coordinate system for the second viewer based on the second location;
identifying a first bundle of beamlets from the MV pixels directed toward the first viewing zone to form a first image based on the first content, and a second bundle of beamlets from the MV pixels directed toward the second viewing zone to form a second image based on the second content; and
outputting control signaling for the MV pixels, the control signaling defining color and brightness of the first bundle of beamlets to form the first image visible to the first viewer in the first viewing zone and defining color and brightness of the second bundle of beamlets to form the second image visible to the second viewer in the second viewing zone.

10. The method of claim 9, wherein the MV display system further includes a mobile device located in proximity to the first location, and the method further comprises:
capturing, by the mobile device, the first registration token;
transmitting, from the mobile device to the system controller processor, the first registration token to initiate a communication session associated with the first viewer;
receiving, by the mobile device, an input from the first viewer;
transmitting, from the mobile device to the system controller processor, the received input through the communication session;
updating, by the system controller processor, the first content based on the received input; and
controlling, by the system controller processor, the MV display to direct the updated first content toward the first location.

11. The method of claim 10, wherein
the first registration token comprises a machine-readable code, and
the capture of the first registration token includes using a camera on the mobile device to scan the machine-readable code.

12. The method of claim 11, wherein the machine-readable code comprises a QR Code, Data Matrix code, Aztec Code, PDF417 code, High-Capacity Color Barcode, or Universal Product Code.

13. The method of claim 10, wherein
the first registration token comprises an alphanumeric string, and
the capture of the first registration token includes the first viewer entering the first registration token into a text field on the mobile device.

14. The method of claim 10, wherein
the first registration token comprises a visual pattern sequence, and
the capture of the first registration token includes the first viewer entering the visual pattern sequence of the first registration token into a user interface on the mobile device.

15. The method of claim 10, wherein
the first registration token comprises a visual avatar, and
the capture of the first registration token includes the first viewer selecting the visual avatar of the first registration token amongst a plurality of options in a user interface on the mobile device.

16. A non-transitory computer readable medium containing content which, when loaded to one or more processors coupled to one or more memory devices, causes the one or more processors to deliver content in a multi-view (MV) display system including a MV display, which includes MV pixels each configured to emit beamlets in different directions in a beamlet coordinate system toward different viewing zones in a viewing zone coordinate system, by:
sensing a first location of a first viewer and a second location of a second viewer;
assigning a first identifier to the first viewer and a second identifier to the second viewer, wherein the first and second identifiers are different;
generating a first registration token and a second registration token, based on the first identifier and the second identifier, respectively;
generating a first content based on the first registration token and a second content based on the second registration token; and
controlling the MV display to direct the first content toward the first location and the second content toward the second location, including:
defining a first viewing zone in the viewing zone coordinate system for the first viewer based on the first location, and a second viewing zone in the viewing zone coordinate system for the second viewer based on the second location;
identifying a first bundle of beamlets from the MV pixels directed toward the first viewing zone to form a first image based on the first content, and a second bundle of beamlets from the MV pixels directed toward the second viewing zone to form a second image based on the second content; and
outputting control signaling for the MV pixels, the control signaling defining color and brightness of the first bundle of beamlets to form the first image visible to the first viewer in the first viewing zone and defining color and brightness of the second bundle of beamlets to form the second image visible to the second viewer in the second viewing zone.
